(19) United States
(12) Patent Application Publication
(10) Pub. No.: US 2004/0081532 A1
(43) Pub. Date: Apr. 29, 2004

(54) Metal plane jointing structure and making method thereof

(76) Inventor: Yuan Liang Yu, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/690,510

(22) Filed: Oct. 23, 2003

Related U.S. Application Data
(62) Division of application No. 10/062,761, filed on Feb. 5, 2002.

(51) Int. Cl. F16B 37/06

(52) U.S. Cl. 411/171

(57) ABSTRACT

A metal plane jointing structure includes a metal plate, a metal joint nut having a periphery flange thereon, and a layer of adhesive glue positioned therebetween. The method of making the structure includes formation and insulation of the metal plate and the metal joint nut, the de-scum process at the joint positions of the metal plate and the metal joint nut, glue coating at the joint positions of the metal joint nut and the metal plate, curing the metal plate and the metal joint nut in the oven after both of them are being positioned, and cooling the jointed metal plate and the metal joint nut at room temperatures.

### BACKGROUND OF THE INVENTION

1. Field of the Invention

The present invention relates to a metal plane jointing structure of and its making method. More particularly, the present invention relates to an improved method for jointing a metal nut onto a thin metal plate. This invention is particularly suitable for a thin—less than 1 mm—metal plate applicable to notebook computers.

2. Description of the Prior Art

As the thickness of a notebook minimizes, so does the associated bottom plate of the notebook. The bottom plate is typically made of metals such as aluminum. The aluminum metal plate is with the superior strength. For connecting elements or devices of a motherboard, some metal nuts are installed on the metal plate. The metal nuts are typically made of metals also.

Referring to FIG. 1 of a perspective view illustrating a metal nut 12 and a metal plate 11 before jointing. There are typically two ways to joint these two devices. The first one is so-called thermal type. As shown in FIG. 2 for the so-called thermal type jointing method, the metal nut 12 is built-in on the metal plate 11. The metal nut 12 and the metal plate 11 are made of the same material such as aluminum. Junctions between the metal nut 12 and the metal plate 11 are thereafter heated. However, some undesirable protrusions are formed on the other side of the metal plate 11 due to heat distortion. To maintain the coherence and appearance of the notebook, an additional polishing process is usually required to remove the protrusions on the metal plate 11. The second approach is known as the soldering type. As shown in FIG. 3 for illustrating the soldering type approach, the bottom periphery of the metal nut 12 is spot-welded on the metal plate 11. Since the soldering type process is also implemented at high circumstance temperatures, the aforementioned problem of protrusion still cannot be solved. It is obvious that the prior art methods are only suitable for jointing “thick” metal plates. When these prior art methods are applied to the “thin” metal plate, the problem of protrusion cannot be avoided and further polishing processes are needed. Moreover, when preparing a conventional metal plate 11, an anode treatment can only be carried out after the soldering process. Consequently, there is a strong desire to provide an improved method to solve the above-mentioned problems.

### SUMMARY OF THE INVENTION

It is a primary object of the present invention to provide an improved metal plane jointing structure and its making method.

According to the claimed invention, a metal plane jointing structure is provided. The jointing structure includes a metal plate, a metal joint nut having a periphery flange thereon, and a layer of adhesive glue positioned between the metal plate and the periphery flange.

The method of making the jointing structure includes following steps:

formating the metal plate;

formating the metal joint nut;

insulating the plate by performing an anodic treatment;

performing a de-scum process at the joint position of the metal plate;

performing the de-scum process at the joint position of the metal joint nut;

coating a glue at the joint position of the metal joint nut or metal plate;

connecting the metal joint nut onto the metal plate;

curing the metal joint nut and metal plate in an oven; and

cooling the metal joint nut and the metal plate down at room temperatures after curing.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is an exploded diagram of the prior art.

FIG. 2 is a first side view of the prior art.

FIG. 3 is a second side view of the prior art.

FIG. 4 is a perspective view illustrating the status of this invention before jointing.

FIG. 5 is a side view of structure of FIG. 4 after jointing.

FIG. 6 is a perspective view of second embodiment according to this invention.

FIG. 7 is a side view of structure of FIG. 4 after jointing.

FIG. 8 is a block diagram depicting the processes of making the structure of this invention.

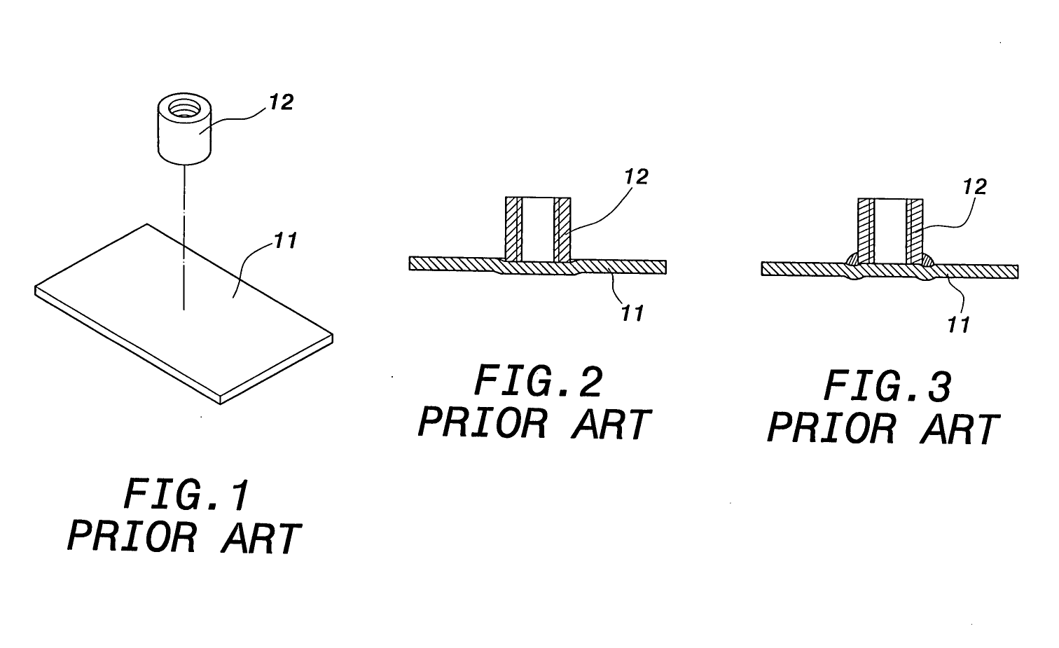

### DETAILED DESCRIPTION OF THE PREFERRED EMBODIMENTS

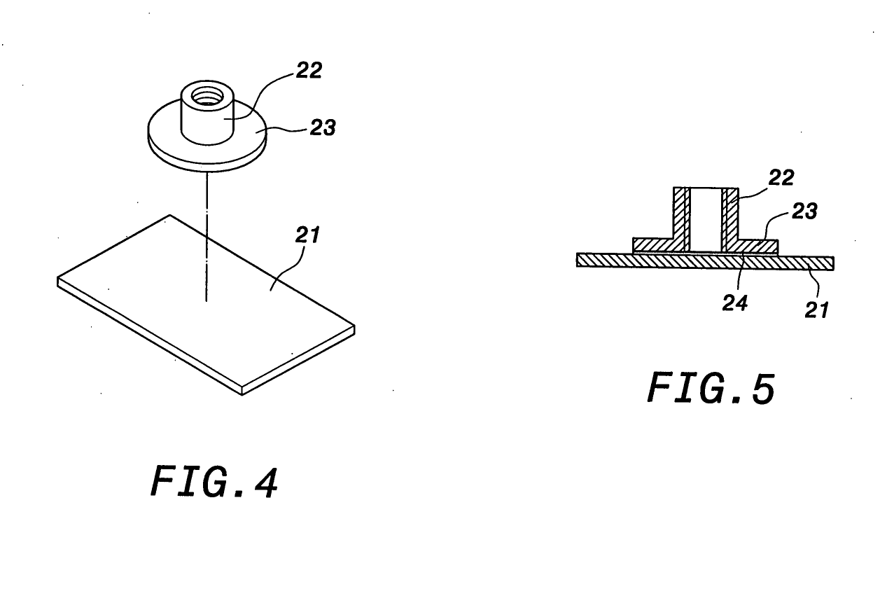

Referring to FIG. 4 and FIG. 5 illustrating the jointing of the metal plate and the metal joint nut according to the present invention. A plate 21 is made of metals. The metal plate 21 has at least one joint nut 22 thereon. The joint nut 22 is also made of metals. The metal joint nut 22 has a threaded inner surface therein for connecting with a screw (not shown). A periphery flange 23 is located at a bottom end of the metal joint nut 22. A layer of adhesive glue 24 is formed between the top surface of the metal plate 21 and the bottom surface of the metal joint nut 22. According to the preferred embodiment, the metal plate 21 is made of aluminum, while the metal joint nut 22 may be made of any typical material known in the art. Preferably, the metal joint nut 22 is made of copper, alloys or the like.

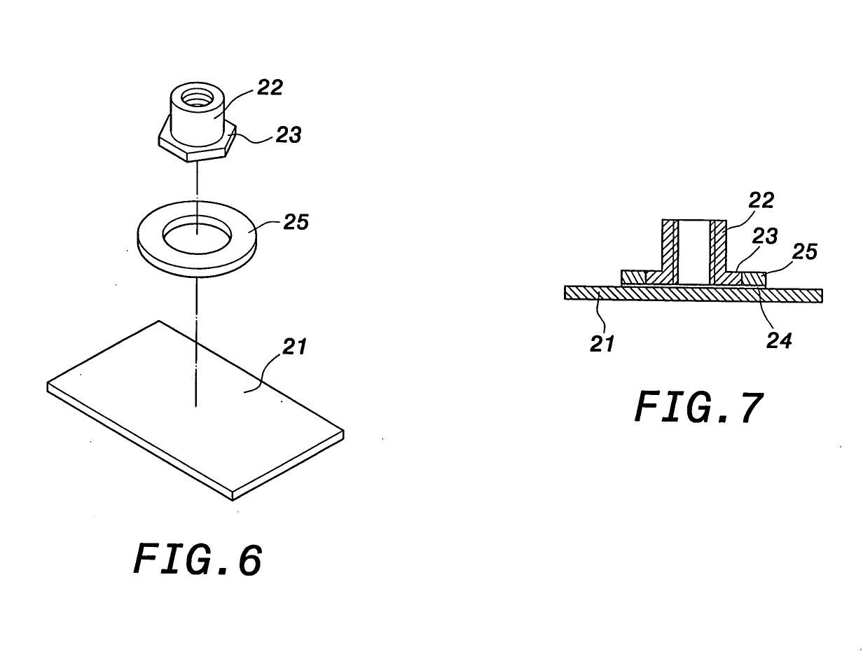

A second embodiment of this invention is shown in FIG. 6 and FIG. 7. Some elements are similar to those of FIG. 4 and are marked with same numerals in FIG. 6 and FIG. 7. As shown in FIG. 6, the periphery flange 23 is hexagonal shaped. However, shapes of the flange are not limited to the hexagonal shape. An extending annular plate 25 with an opening at its center is positioned abutting upon the periphery flange 23. The goal of using the annular plate 25 is to increase the contact surface between the metal nut 22 and the metal plate 21. In FIG. 6, the annular plate 25 is circular in its inner and outer side. The inner side is jointed with the hexagonal joint flange 23 by prior known methods, for example, the jet-pressing jointing process. The bottom surface of the joint flange 23 and the annular plate 25 may be firmly fixed on the plate 21 by means of a layer of adhesive glue 24. Preferably, the adhesive glue is epoxy resin with the high anti-strip ability, high stress strength, high impact strength, strong resistance to chemicals and solvents, and being superior electric duration.

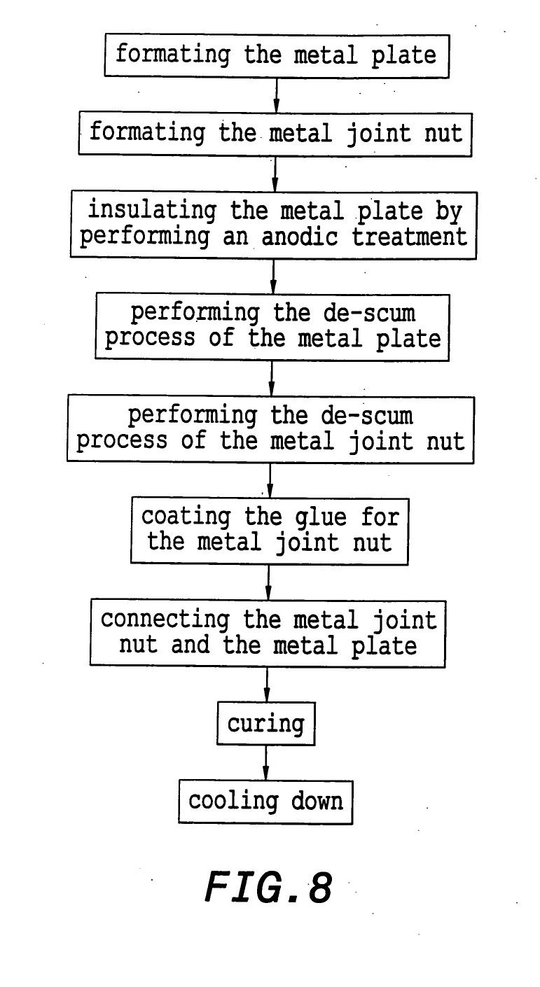

FIG. 8 displays a block diagram of this invention. The making processes are explained as follows:

(a) formating the metal plate;

(b) formating the metal joint nut;

(c) insulating the metal plate by performing an anodic treatment, which is for strengthening the resistance of the metal plate surface to counter scratches and oxidants;

(d) performing a de-scum process at the joint position of the metal plate;

(e) performing the de-scum process at the joint position of the metal joint nut;

(f) coating a glue at the joint position of the bottom surface of the metal joint nut and the top surface of the metal plate;

(g) connecting the metal joint nut and the metal plate;

(h) curing the metal joint nut and the metal plate in an oven for 4 minutes at 200° C.; and

(i) cooling the metal joint nut and the metal plate down at room temperatures.

To improve the quality of adhesion, the step (d) may further comprise the step of polishing the surface of the metal plate at the joint position. Or, the step (e) may further comprise another step of polishing the jointing face of the metal joint nut. According to stretching test results, the product made in accordance with the above processes has proved that it is better than standard values. Hence, the method of this invention is practicable.

In short, we discover that products made by specific processes have the better adhesion ability with smoother joint surface of the metal plate and the larger contact surface of the metal joint nut. Moreover, the anodic treatment may be carried out before the glue coating step. By this way, the plate is processed directly into a final product.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A metal plane jointing structure comprising:
a metal plate;
a metal joint nut having a periphery flange thereon; and
a layer of adhesive glue positioned between the metal plate and the periphery flange.

2. The metal plane jointing structure of claim 1 wherein the metal plate is made of aluminum.

3. The metal plane jointing structure of claim 1 further comprising an annular plate tightly surrounds the periphery flange for increasing the contact surface between the metal joint nut and the metal plate.

4. The metal plane jointing structure of claim 1 wherein the adhesive glue is an epoxy resin.

5. A making method for a metal plane jointing structure comprising:
(a) forming a metal plate;
(b) forming a metal joint nut;
(c) insulating the metal plate by performing an anodic treatment;
(d) performing a de-scum process at the joint position of the metal plate;
(e) performing the de-scum process at the joint position of the metal joint nut;
(f) coating a glue at the joint position of the metal joint nut or the metal plate;
(g) connecting the metal joint nut onto the metal plate;
(h) curing the metal joint nut and the metal plate in an oven; and
(i) cooling down at the room temperature.

6. The method of claim 5 wherein the step (d) further comprises polishing the surface of the metal plate at the joint position.

7. The method of claim 5 wherein the step (e) further comprises polishing the jointing face of the metal joint nut.

8. The method of claim 5 wherein in step (h) is carried out for 4 minutes at 200° C.
